(19) United States
(12) Patent Application Publication
(10) Pub. No.: US 2009/0160900 A1
(43) Pub. Date: Jun. 25, 2009

(54) REGISTRATION ERROR DETECTION METHOD AND INKJET IAMGE FORMING DEVICE

(75) Inventors: Hirohisa Niida, Tokyo (JP); Shinichi Saijo, Noda-shi (JP); Jouji Odaka, Saitama-shi (JP)

Correspondence Address: PATENTTM.US, P. O. BOX 82788, PORTLAND, OR, 97282-0788, US

(73) Assignee: CANON FINETECH INC., Misato-shi (JP)

(21) Appl. No.: 12/334,399

(22) Filed: Dec. 12, 2008

(30) Foreign Application Priority Data
Dec. 19, 2007 (JP) 2007-327172

(51) Int. Cl. B41J 29/393

(52) U.S. Cl. 347/19

(57) ABSTRACT

An inkjet image forming device records a test pattern 901 composed of plural lines running along the nozzle array, at least one end positions of the lines being shifted in increments of one unit amount, using a first line recording head 202. After that, the same test pattern as the test pattern described above is sequentially recorded using the second and the subsequent line recording heads, 203-205. The lines of each recorded test pattern are detected by an optical sensor 210 provided downstream of the plural line recording heads. Based on the detection results of the lines of the test patterns recorded by the line recording heads, the amounts of nozzle array direction registration errors between the line recording head, which is one of the plural line recording heads and is used as the base, and other line recording heads are detected. Based on the amounts of errors, the registration of the line recording heads is corrected. This configuration adjusts the registration among the line recording heads relatively accurately and speedily in a relatively low-cost system configuration.

### DETAILED DESCRIPTION

1. Field of the Invention

The present invention relates to an inkjet image forming device that records an image on a recording medium conveyed in a direction substantially orthogonal to the direction along each nozzle array of plural line recording heads each of which has an array of linearly arranged nozzles, and more particularly to a method for detecting the amounts of registration errors among line recording heads in the nozzle array direction.

2. Description of the Related Art

Conventionally, an inkjet image forming device, which records an image by the use of the recording heads based on the inkjet recording method, uses recording heads of plural ink colors, such as black, yellow, magenta, and cyan, for full color recording. On such an inkjet image forming device, a registration adjustment is made for correcting registration errors by recording a predetermined test pattern using those plural recording heads and detecting the amounts of registration errors among the recording heads (see Patent Document 1).

An inkjet recording device using a so-called line type recording head that extends across the full width of the recording medium is also known (see Patent Document 2).

Conventionally, an inkjet image forming device on which plural line recording heads are arranged in parallel is known. The same color (for example, black) ink is ejected from those plural line recording heads to perform a so-called raster division recording in which rasters, which constitutes an image to be recorded, are recorded by the plural line recording heads. This recording method increases the recording speed.

In any case, a registration measuring test pattern is recorded conventionally to correct recording position errors, that is, registration errors, among the plural line recording heads. Generally, an operator visually checks the recording result and, based on the registration adjustment values read from the test pattern, adjusts the registration in recording position of each line recording head in two directions, the nozzle array direction and the direction orthogonal to the nozzle array direction.

In addition, when a line recording head is exchanged, there is a possibility that a misregistration occurs again among the line recording heads and, so, each time a line recording head is exchanged, the operator must record a registration measuring test pattern for registration adjustment.

Patent Document 1: Japanese Patent Laid-Open Publication No. Hei 7-323582

Patent Document 2: Japanese Patent Laid-Open Publication No. 2004-106359

One of the problems with the conventional registration adjustment described above is that it is difficult for the operator, who reads the registration adjustment values from a recorded test pattern, to visually check the result accurately. This means that, in some cases, the visual check is not suitable for the registration adjustment that requires high accuracy.

Another problem is that it takes long for the operator to visually check the recorded registration measuring test pattern and to read the registration adjustment values. Sometimes, a user unfamiliar with this check finds it difficult to perform this operation. Registration adjustment must be made each time a line recording head is exchanged or the inkjet image recording device is moved or its arrangement is changed, making the operation still more difficult and cumbersome.

An example of the reader for automatically adjusting the registration is an image reading device such as a CCD sensor. The image reading device such as a CCD sensor is more expensive than an optical sensor. In addition, the reader used for automatically adjusting the registration by means of the image reading device, such as a CCD sensor, requires a complex image analysis system for analyzing an image that is read.

### SUMMARY OF THE INVENTION

In view of the foregoing, it is an object of the present invention to provide a registration error detection method and an inkjet image forming device that can adjust the registration among the line recording heads relatively accurately and speedily in a relatively low-cost system configuration.

For use in an inkjet image forming device that records an image while conveying a recording medium below a plurality of line recording heads in a direction substantially orthogonal to a nozzle array direction, a registration error detection method according to the present invention for detecting a registration error in the nozzle array direction among the plurality of line recording heads, each having a linearly-arranged nozzle array, comprises the steps of recording, by each of the line recording heads, a test pattern composed of a plurality of lines running along the nozzle array, at least one end positions of the lines being shifted in increments of one unit amount; detecting, by an optical sensor, lines of the test pattern recorded by each of the line recording heads, the optical sensor being provided downstream of the plurality of line recording heads in a conveyance direction of the recording medium; and detecting an amount of registration error in the nozzle array direction between one line recording head, which is one of the plurality of line recording heads and is used as a base, and other line recording heads, based on line detection results of the test patterns recorded by the line recording heads.

An inkjet image forming device according to the present invention that records an image while conveying a recording medium below a plurality of line recording heads in a direction substantially orthogonal to a nozzle array direction, each having a linearly-arranged nozzle array, comprises a recording unit that records, by each of the line recording heads, a test pattern composed of a plurality of lines running along the nozzle array, at least one end positions of the lines being shifted in increments of one unit amount; an optical sensor provided downstream of the plurality of line recording heads in a conveyance direction of the recording medium; and a control unit that causes the optical sensor to detect the lines of the test pattern recorded by each line recording head, finds an amount of registration error in the nozzle array direction between one line recording head, which is one of the plurality of line recording heads and is used as a base, and other line recording heads based on line detection results of the test patterns recorded by the line recording head, and corrects a nozzle array direction registration of each line recording head based on the amount of error.

According to the present invention, a test pattern recorded by each line recording head is read, immediately after it is recorded, by the optical sensor provided downstream in the recording medium conveyance direction. The configuration of the test pattern composed of plural lines running along the nozzle array, one end positions of the lines being shifted in increments of one unit amount, allows the amount of registration error in the nozzle array direction to be detected based on the presence/absence detection result of lines in the test pattern.

When the inkjet image forming device has at least first and second recording units arranged in tandem, the optical sensor is shared by the first and second recording units each of which includes the plurality of line recording heads.

When the inkjet image forming device has at least first and second recording units arranged in different positions in the width direction of a recording medium for causing the first and second recording units to record images in different parts on the recording medium in the width direction, the recording units are arranged so that parts of nozzle arrays of neighboring recording units are overlapped with each other in the width direction, the test pattern is recorded in the overlapped nozzle part, and the optical sensor is provided in the overlapped area of the neighboring recording units to allow the neighboring recording units to share the same optical sensor, each of the first and second recording units including the plurality of line recording heads.

In any case, with a base line recording head of a specific recording unit as a base, the amount of error of all line recording heads of other recording units are detected and corrected.

According to the present invention, the inkjet image forming device having plural line recording heads can automatically detect and correct the amounts of registration error in the nozzle array direction among plural line recording heads based on the predetermined test pattern and the optical sensor. This inkjet image forming device eliminates the need for the user to make the visual check and allows the user to make the check accurately and quickly. A reflective optical sensor, which is used as the optical sensor, requires little or no additional device cost.

### BRIEF DESCRIPTION OF THE DRAWINGS

FIGS. 1A, 1B and 1C are diagrams showing three modes representing the relation between recording units and a recording medium in an embodiment of the present invention.

FIG. 2 is a diagram showing an example of the general configuration of one recording unit shown in FIGS. 1A, 1B, and 1C.

FIG. 3 is a block diagram showing the general control hardware of an image forming device in the embodiment of the present invention.

FIG. 4 is a diagram showing the recording control by means of the so-called raster division in the image forming device used in the embodiment of the present invention.

FIG. 5 is a diagram showing the general registration adjustment in the nozzle array direction in the image forming device that has plural line recording heads.

FIG. 6 is a diagram continued from FIG. 5.

FIG. 7 is a diagram showing a registration measuring test pattern used in the embodiment of the present invention.

FIG. 8 is a diagram schematically showing how a reflective optical sensor, a reader in the embodiment of the present invention, detects a test pattern.

FIG. 9 is a diagram showing how the reflective optical sensor samples each of test patterns recorded similarly by different line recording heads.

FIG. 10 is a diagram continued from FIG. 9.

FIG. 11 is a flowchart showing an example of the actual procedure for adjusting the registration in the embodiment of the present invention.

FIG. 12 is a diagram showing an example of a modification of the test pattern in the embodiment of the present invention.

FIG. 13 is a diagram showing an example of another modification of the test pattern in the embodiment of the present invention.

FIG. 14 is a diagram showing a still another example of a modification of the test pattern in the embodiment of the present invention.

FIG. 15 is a diagram showing an example of a modification of the test pattern in FIG. 14.

FIG. 16 is a diagram showing the measurement of the test pattern in FIG. 15.

FIG. 17 is a diagram showing the registration adjustment in a system in which plural recording units are arranged in tandem as in FIG. 1C.

FIG. 18 is a diagram showing the registration adjustment in a system in which plural recording units are arranged in zigzag as in FIG. 1B.

FIG. 19 is a diagram showing an example of a test pattern for the registration adjustment in the direction orthogonal to the nozzle array direction.

### DETAILED DESCRIPTION OF PREFERRED EMBODIMENT

An inkjet image forming device in an embodiment of the present invention will be described in detail below with reference to the drawings.

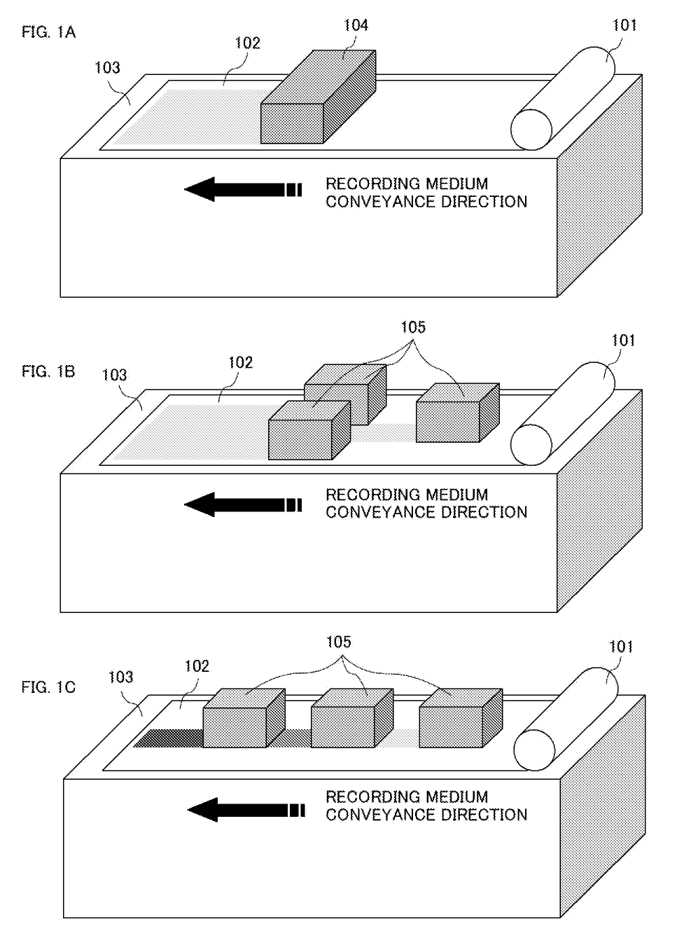

FIGS. 1A, 1B, and 1C are diagrams showing three modes representing the relation between recording units and a recording medium in this embodiment. In any of those modes, the recording units are fixed and, in relation to those recording units, a recording medium 102 is conveyed in the direction in which it crosses below the recording part of the recording units.

FIG. 1A is a diagram showing the configuration in which a single recording unit 104, which contains plural line recording heads arranged in parallel, is combined with the recording medium 102. In this configuration, continuous recording paper unrolled from rolled paper 101 is used as the recording medium 102. The length of the nozzle array of one line recording head extends across the full width of the recording medium 102. In relation to the fixed recording unit 104, the recording medium 102 is conveyed in the direction orthogonal to the nozzle array. When the ink colors of the plural line recording heads are different, an image can be recorded in full color. When the ink colors of the plural line recording heads are the same (for example, black), an image can be recorded speedily in monochrome.

FIG. 1B is a diagram showing the configuration in which plural recording units 105 are arranged in zigzag. In this configuration, the length of the nozzle array of one line recording head is smaller than the full width of the recording medium 102, and each recording unit is responsible for recording in a specific part (different width part) of the full width of the recording medium 102. The neighboring recording units have respective parts of their nozzle arrays overlapped with each other at the boundary to prevent a blank from being printed at the boundary. Although three recording units 105 are shown in the figure, this configuration is not limited to the three recording heads but any plural recording units may be used.

FIG. 1C is a diagram showing the configuration in which plural recording units 105 are arranged in tandem (that is, serially in the conveyance direction of the recording medium). In this case, the length of the nozzle array of one line recording head should preferably extend across the full width of the recording medium 102 as in the configuration in FIG. 1A. This configuration is suitable for full-color, high-speed recording. This configuration may also be combined with the configuration in FIG. 1A and FIG. 1B.

With the plural independent recording units such as those in FIGS. 1B and 1C are used, a registration error may occur not only among the plural line recording heads in each recording unit but also among plural recording units. Those registration errors must be detected and corrected (that is, registration adjustment is necessary).

When an inkjet image forming device having plural line recording heads is moved or its arrangement is changed, an error sometimes occurs in position of the line recording heads or in position the recording units. So, each time an inkjet image forming device is moved or its arrangement is changed, a registration measuring test pattern should preferably be formed for registration adjustment.

With respect to registration errors in the nozzle array direction (i.e. the horizontal direction for convenience) of an inkjet image forming device having plural line recording heads, a reflective optical sensor, a reader for reading a registration measuring test pattern, is provided downstream of the line recording heads in the conveyance direction. This configuration makes it possible to provide automatic, speedy, and accurate registration adjustment of the line recording heads. In this embodiment, the registration adjustment is made primarily in the nozzle array direction of the line recording heads. This registration adjustment, designed to record a predetermined test pattern and to detect and correct registration error amounts, can be executed automatically at a predetermined time according to a user instruction. Unlike the conventional registration adjustment, this registration adjustment eliminates the need for the user to visually check the recording result of a test pattern and to enter correction values.

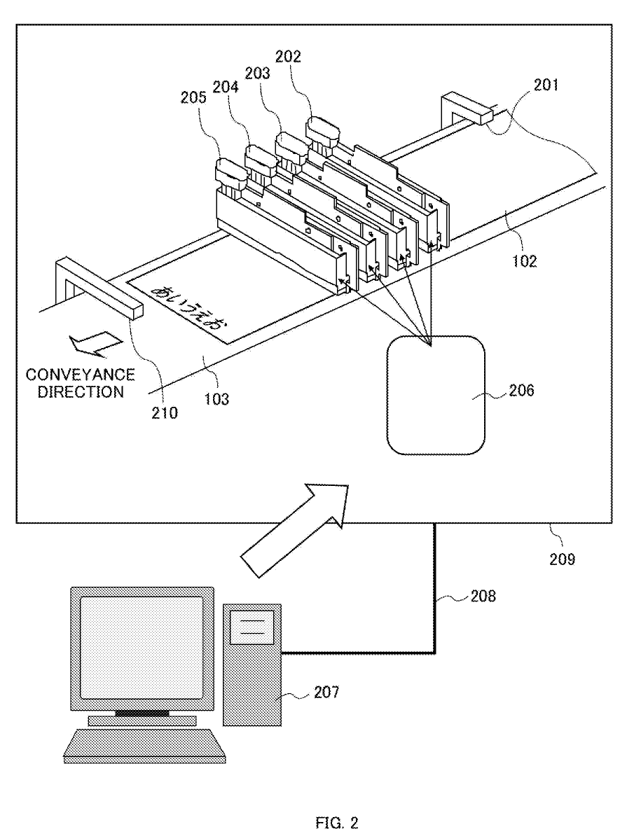

FIG. 2 is a diagram showing an example of the general configuration of one recording unit such as the recording units 104 and 105 in FIGS. 1A, 1B, and 1C.

A recording unit has plural (four in this example) line recording heads 202-205 arranged in parallel. In this embodiment, an example of a monochrome inkjet image forming device 209, in which all line recording heads eject the same color (black) ink, is used. Ink is supplied from a common ink tank 206 to the line recording heads, a conveyance unit 103 is driven to feed the recording medium 102 below the line recording heads and, when a recording medium detection sensor 201 detects the recording medium, the line recording heads 202-205 start to record an image on the recording medium 102 in synchronization with the output from the encoder that will be described below.

The image forming device 209 also has a reflective optical sensor 210 as a reader for reading a registration measuring test pattern. At least when the test pattern is read, this reflective optical sensor 210 is located downstream of the line recording heads 202-205 for reading the registration measuring test pattern recorded on the recording medium 102 by the line recording heads 202-205. The reflective optical sensor 210, either fixed or movable, is fixed at a predetermined position at least when the test pattern is read.

This image forming device 209 and a host computer 207 are connected via a printer cable 208 to record various types of data, processed by the host computer 207, on the image forming device 209 and, then, to allow the host computer 207 to detect the printer status such as error information on the image forming device 209.

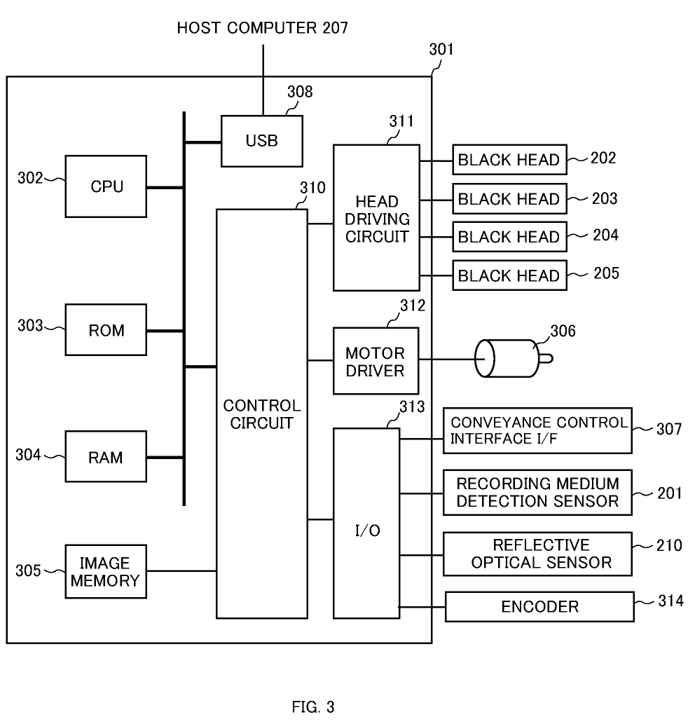

FIG. 3 is a block diagram showing the general control hardware of one recording unit of the image forming device in this embodiment.

A control unit 301, which comprises a processing unit (CPU) 302, executes a control program stored in a memory (ROM) 303 and controls the parts of the device and various peripheral devices. The control unit 301 further comprises a memory (RAM) 304 used as the working area and the receiving buffer for processing various types of data and an image memory 305 used as the image expansion unit. In addition, under control of the CPU 302 and via a control circuit 310, this control unit 301 controls a head driving circuit 311, a motor driver 312, and an I/O interface 313. The head driving circuit 311 drives the line recording heads 202-205. The motor driver 312 controls various motors 306 that control the cleaning operation, which keeps the line recording heads in the optimum state for recording, and the recording operation. The I/O interface 313 is connected to a conveyance control interface 307 that acts as the interface with the conveyance unit 103 (FIGS. 1A, 1B, and 1C) that feeds the paper below the line recording heads, the recording medium detection sensor 201, the reflective optical sensor 210, and an encoder 314 for performing control and communication operations according to the sensor output. The encoder 314 outputs the pulse signal in synchronization with the conveyance of a recording medium and, based on this output, calculates the conveyance amount and the conveyance speed of the recording medium.

This image forming device receives image data and a cleaning command, etc. received basically from the host computer 207, by means of a USB control unit 308 via a printer cable such as a USB cable and performs the operation according to the received command instructions.

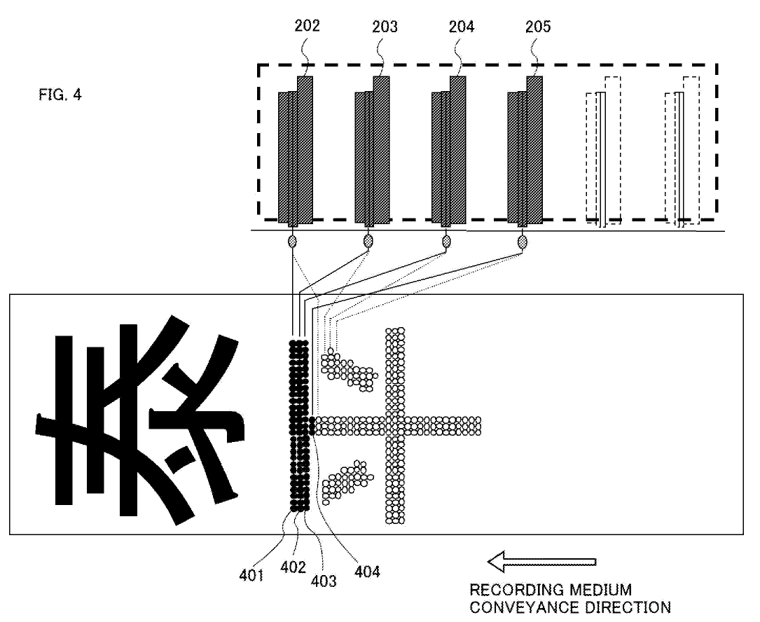

FIG. 4 is a diagram showing the recording control based on the so-called raster division in the image forming device used in this embodiment.

A raster drawing (401) is created by transferring one raster of data from the image memory 305 (FIG. 2) to a first black head 202 at a time determined by the detection signal from the recording medium detection sensor 201 (FIG. 2) and the output pulse from the encoder 314 (FIG. 2). Similarly, the next raster drawing (402) is created by transferring the next one raster of data from the image memory 305 to a second black head 203 at the next time determined by the encoder 314. In addition, a raster drawing (403) is created by transferring the next one raster of data from the image memory 305 to a third black head 204 at the next detection time determined by the encoder 314. Similarly, a raster drawing (404) is created by transferring the next one raster of data from the image memory 305 to a fourth black head 205 at the next time. Thereafter, an output image is created by recording plural rasters similarly by the black heads 202-205, one raster at a time.

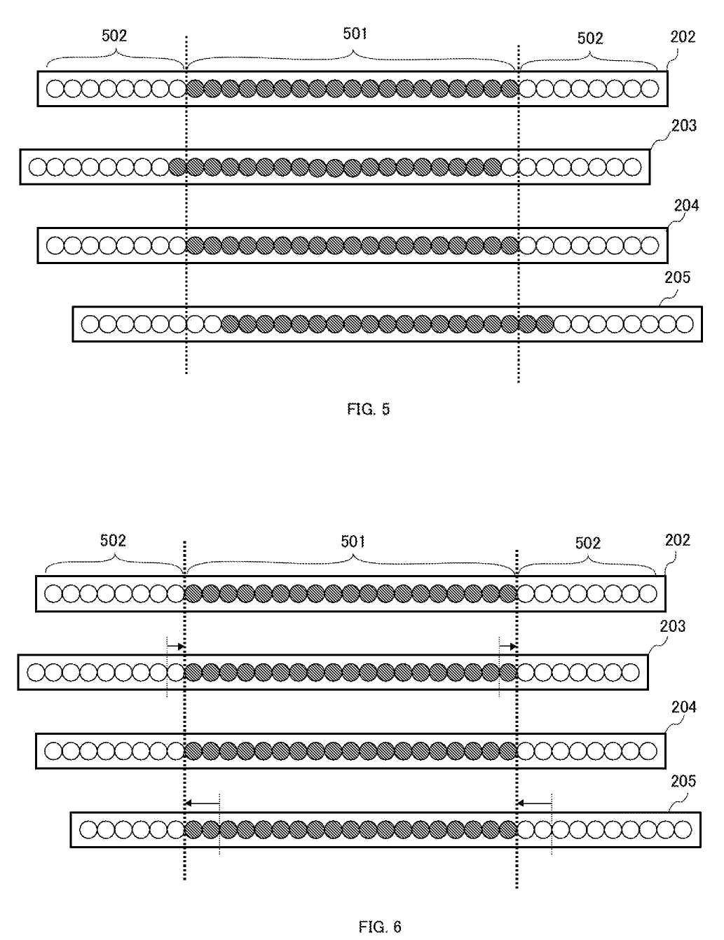

FIG. 5 and FIG. 6 are diagrams showing the general registration adjustment in the nozzle array direction in the image forming device that has the line recording heads 202-205.

In general, each of the line recording heads 202-205 has a nozzle group 501 including nozzles that provides the effective recording area width, together with correction nozzle groups 502 each composed of relatively small number of nozzles, one to the left, and the other to the right, of the nozzle group 501. This nozzle arrangement allows the range of nozzles, which will be used for recording, to be set selectively to make it possible to adjust the actual raster recording position in the nozzle array direction. For example, consider that an error occurs in the installation positions of the black heads 202-205 in the nozzle array direction as shown in FIG. 5. In this example, when the first line recording head 202 is the base head, the second line recording head 203 is shifted by one dot to the left in the figure and the fourth line recording head 205 is shifted by two dots to the right. (Note that there is no shift between the third line recording head 204 and the line recording head 202 in the nozzle array direction) In this case, the recording positions of the line recording heads can virtually be corrected, not by correcting the actual setting positions of the line recording heads, but by shifting the range of nozzle arrays that will be used. Although this correction method is a known method, the present invention is characterized in that the registration error amount, which will be corrected, is automatically detected.

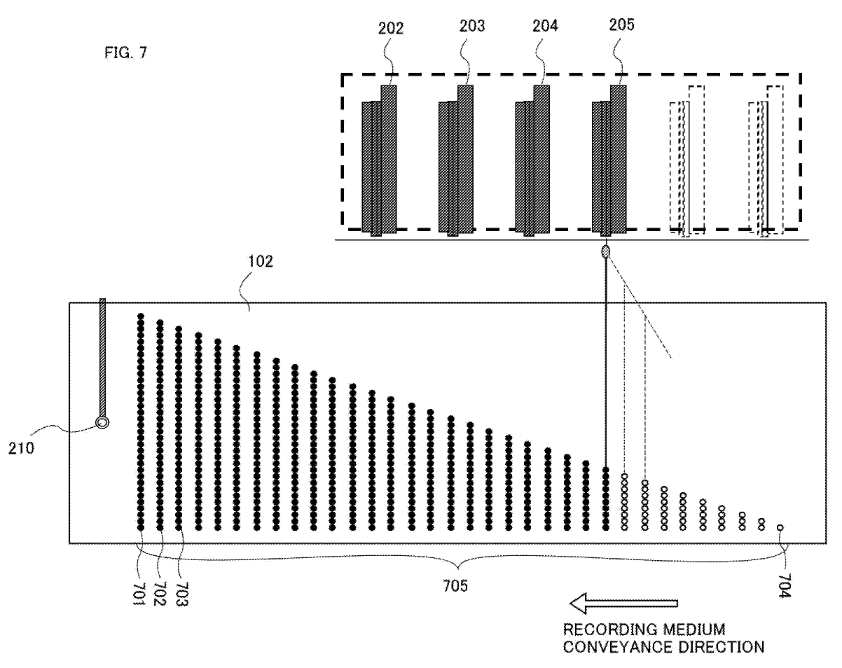

FIG. 7 is a diagram showing a registration measuring test pattern 705 used in this embodiment. Ones of the test pattern 705 are sequentially recorded by all line recording heads 202-205 and are detected by the optical sensor 210 provided downstream of the recorded position. For convenience, FIG. 7 shows only one test pattern 705. One test pattern 705 is recorded, not in raster division recording format described above, but by a single line recording head. This figure shows the test pattern 705 that is being recorded by the line recording head 205. Although the order in which the line recording heads 202-205 are used to record respective ones of the test pattern 705 is not limited to a specific order, the test patterns are recorded by the line recording heads in order of their reference numerals in this embodiment.

The test pattern 705 is composed of plural lines. At least one end of those plural lines changes in increments of one unit amount, and those lines run parallel to the nozzle arrays. In other words, the test pattern has a shape one end of which is shifted in increments of one unit amount, line by line, each line being of a predetermined line width. In this embodiment, the “unit amount” refers to one dot corresponding to one nozzle. In the example in the figure, the position of one end of each line is shifted inward, on dot by one dot. The other end positions of the lines remain unchanged. So, the number of dots of a line 701 that is recorded first in the nozzle array direction in this test pattern 705 is the largest (that is, the longest line), and the number of dots is decreased, one dot by one dot, for each of a second line 702, a third line 703, and so on (that is, the line length gets shorter).

The width of one line is of the number of unit dots. In the example shown in FIG. 7, the number of unit dots is one dot. As will be described below, the line width may be of plural dots. The neighboring lines have a blank area between them. The space between the neighboring lines is set at least large enough for the optical sensor 210 to detect the blank area between the two lines.

The read area of the reflective optical sensor 210 may be of a narrow area wide enough for the reflective optical sensor to detect a recorded one dot or plural neighboring dots. The position where the optical sensor 210 is located is the position corresponding to the midpoint nozzle of all nozzle arrays downstream of all line recording heads. That is, when the recording medium 102 is conveyed, it is required that the line 701 that is the first recorded line of one test pattern 705 crosses the read area of the reflective optical sensor 210 that reads the test pattern 705 and that a line 704 that is the last recorded line does not cross the read area of the reflective optical sensor 210. (Note that the actual length of the lines to be recorded may be shorter than, and the actual number of lines may be smaller than, those shown in the figure as mentioned below.)

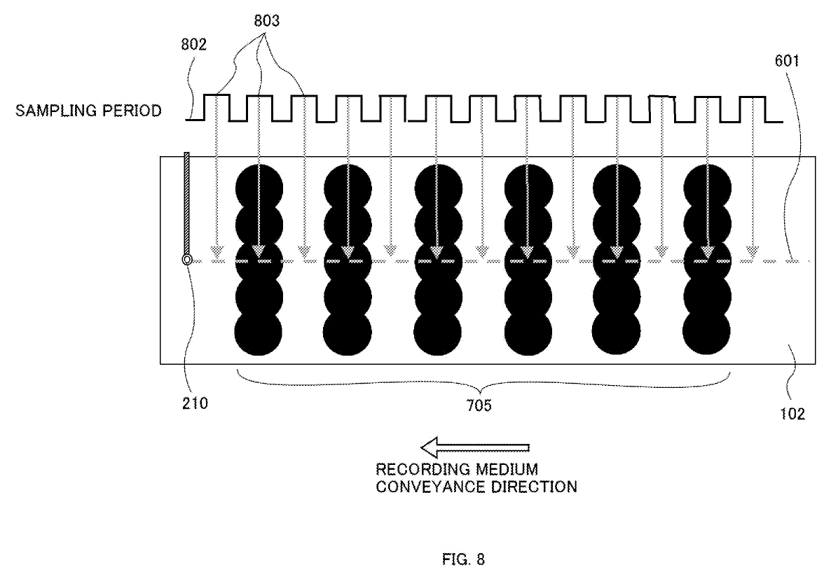

FIG. 8 is a diagram schematically showing how the reflective optical sensor 210, a reader in this embodiment, detects the test pattern 705.

The reflective optical sensor 210 reads the test pattern 705 directly below its located position. As the recording medium 102 moves in the conveyance direction, the optical sensor 210 scans along the line shown by a dotted line 601. The reflective optical sensor checks the presence/absence of a line according to the sampling period, which synchronizes with the movement speed of the recording medium 102, based on the output of the encoder described above. In the example shown in the figure, the optical sensor checks the presence/absence of a line when a sampling signal 802 is high. The method of checking line presence/absence is not limited to this method. For example, the line presence/absence may be checked by digitizing the analog signal output from the optical sensor 210.

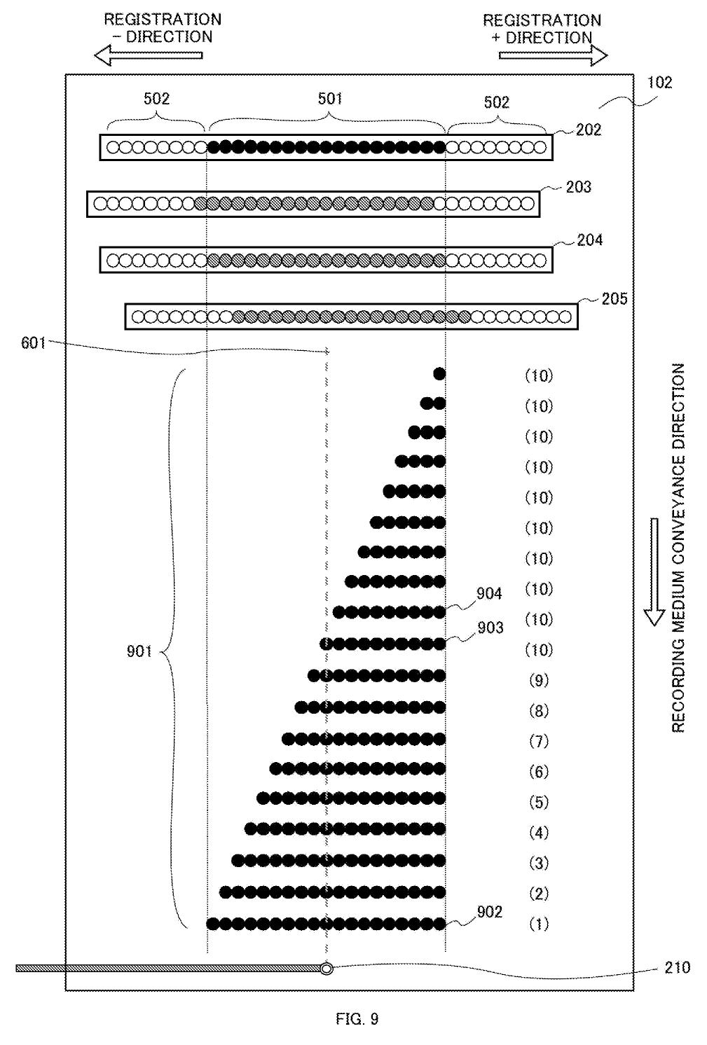

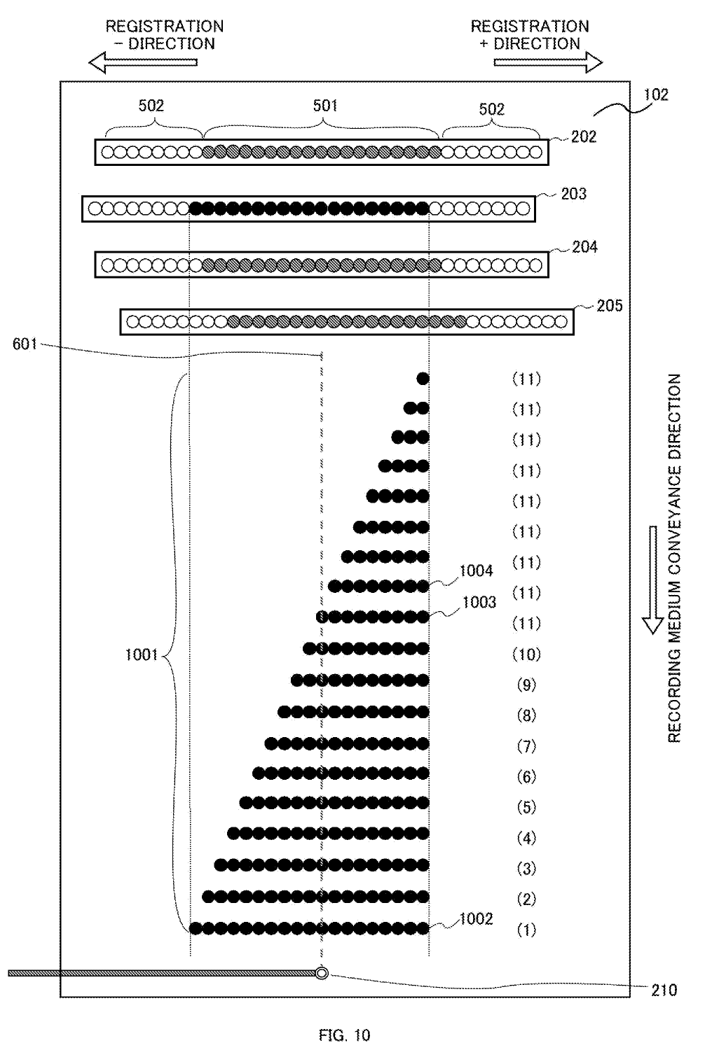

FIG. 9 and FIG. 10 are diagrams showing how the reflective optical sensor 210 samples each of test patterns 901 and 1001 recorded in the same way by different line recording heads (202 and 203 in this example).

As shown in FIG. 9, lines detected by the optical sensor 210 are counted for the test pattern 901 recorded by the first line recording head 202. In the figure, the numeric value in parentheses beside each line indicates the count value of lines (number of lines counted) detected up to that line. (Note that numbers in parentheses are not a part of the test pattern.) In the example shown in the figure, line 902 to line 903 are detected but line 904 and the subsequent lines are not detected. So, as the recording medium is conveyed, the count value of lines increases one by one from the initial value of 0 until it reaches 10 where the counting stops.

On the other hand, as shown in FIG. 10, the test pattern 1001 recorded by the second line recording head 203, though recorded based on the same data as that of the test pattern 901, is recorded with the test pattern shifted in the nozzle array direction due to a registration error of the line recording head. It should be noted that the position of the optical sensor 210 in the nozzle array direction with respect to the test pattern remains unchanged. As a result, for the test pattern 1001 recorded by the line recording head 203, the lines are counted from line 1002 to line 1003 but the next line 1004 and the subsequent lines are not counted. So, as the recording medium is conveyed, the count value increases one by one from the initial value of 0 until it reaches 11 where the counting stops. The difference, 1, between the final count values of the two line recording heads corresponds to the amount of registration error between the two line recording heads. The direction of error is indicated by the sign (positive or negative) of the difference.

Although not shown in the figure, the similar test patterns are recorded for the third and fourth line recording heads 204 and 205, and the lines are counted. The difference between the final count value of the test pattern of each of those line recording heads and the final count value of the test pattern of the first line recording head 202 corresponds to the amount of registration error (amount of shift) between each of the third and fourth line recording heads and the first line recording head.

So, the recording range of each nozzle array of the second to fourth line recording heads is moved in the direction, in which the calculated registration error is canceled, for correcting the registration error between that line recording head and the first line recording head, which is the base head, on a dot basis.

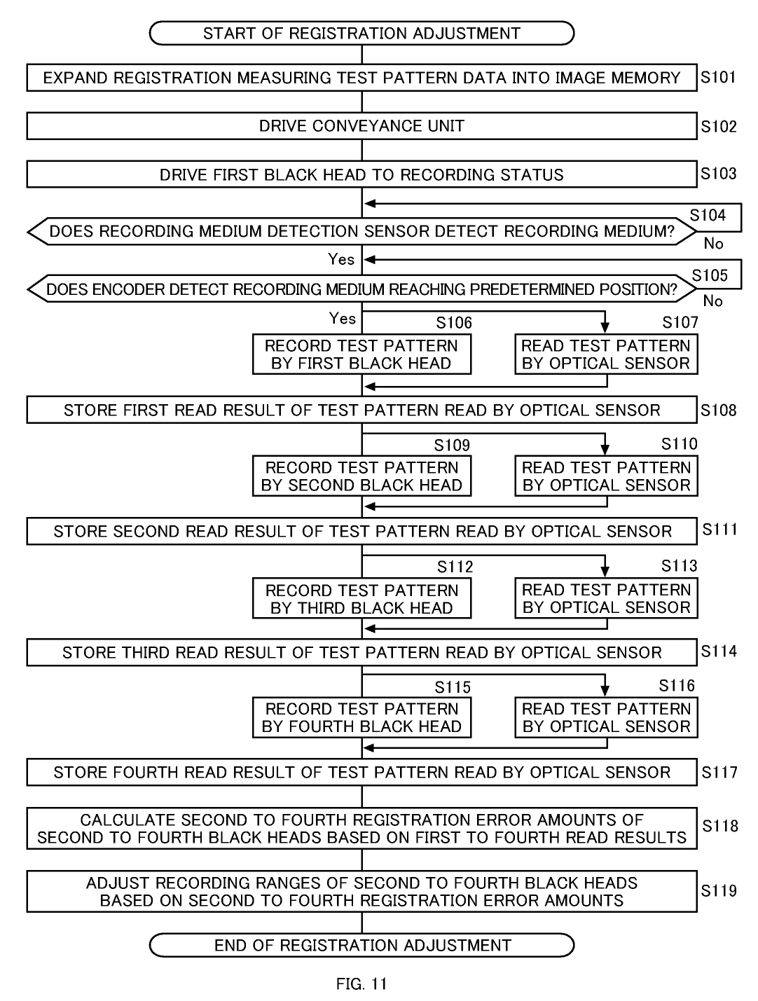

FIG. 11 is a flowchart showing an example of the actual procedure for adjusting the registration in this embodiment. This processing is executed by the CPU 302, shown in FIG. 3, that reads the program from the ROM 303 for execution.

First, the test pattern data for recording the registration measuring test pattern in this embodiment is expanded in the image memory (S101). The test pattern data may also be stored in the image forming device or may be received from an external device such as the host computer 207. After that, the conveyance unit is driven (S102). The conveyance unit, which is driven, feeds and conveys the recording medium. The first to fourth black heads (line recording heads) are driven to the recording status (S103). This operation corresponds to the operation to move the line recording heads from the retracted position, not shown, to the recording position.

Next, after the recording medium is detected by the recording medium detection sensor (S104, Yes), the CPU waits for the encoder to detect the recording medium reaching a predetermined position (S105, Yes) and executes the following processing.

First, the test pattern is recorded by the first black head (S106) and, then, the test pattern is read by the optical sensor (S107). After that, the first read result of the test pattern read by the optical sensor is stored (S108).

Next, the test pattern is recorded by the second black head (S109) and, then, the test pattern is read by the optical sensor (S110). The second read result of the test pattern read by the optical sensor is stored (S111).

Next, the test pattern is recorded by the third black head (S112) and, then, the test pattern is read by the optical sensor (S113). The third read result of the test pattern read by the optical sensor is stored (S114).

In addition, the test pattern is recorded by the fourth black head (S115) and, then, the test pattern is read by the optical sensor (S116). The fourth read result of the test pattern read by the optical sensor is stored (S117).

Based on the first to fourth read results obtained in this way, the second to fourth registration error amounts of the second to fourth black heads are calculated with the first black head as the base head (S118). Based on the calculated second to fourth registration error amounts, the recording ranges of the nozzle arrays of the second to fourth black heads are adjusted (S119).

With one line recording head determined as the base head, the processing sequence described above allows automatically to identify the registration error amounts of the other three line recording heads in the nozzle array direction on a dot basis and, based on the identified values, to correct the registration errors in the nozzle array direction of the line recording heads 203 to 205.

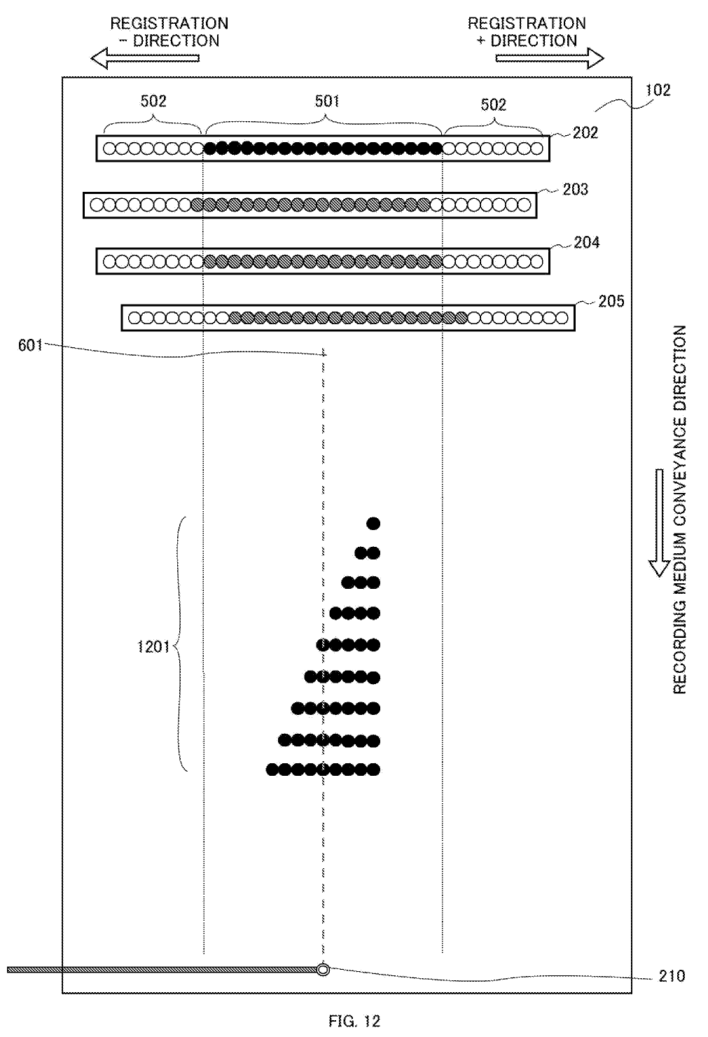

FIG. 12 is a diagram showing an example of a modification of the test pattern. In the test pattern shown in FIG. 7, the entire nozzle group 501 of each line recording head is used to record the test pattern. Actually, however, the maximum value of a registration error in the line recording heads is limited, with its absolute value being equal to or smaller than the size of the correction nozzle group 502. Therefore, an area about the size of the sum of nozzles of two nozzle groups 502 is large sufficient as an area for recording the test pattern. As a result, the number of lines of one test pattern 1201 is reduced. This test pattern also reduces the time required for sequentially and serially recording the test patterns, one for each line recording head, and reduces the amount of recording medium.

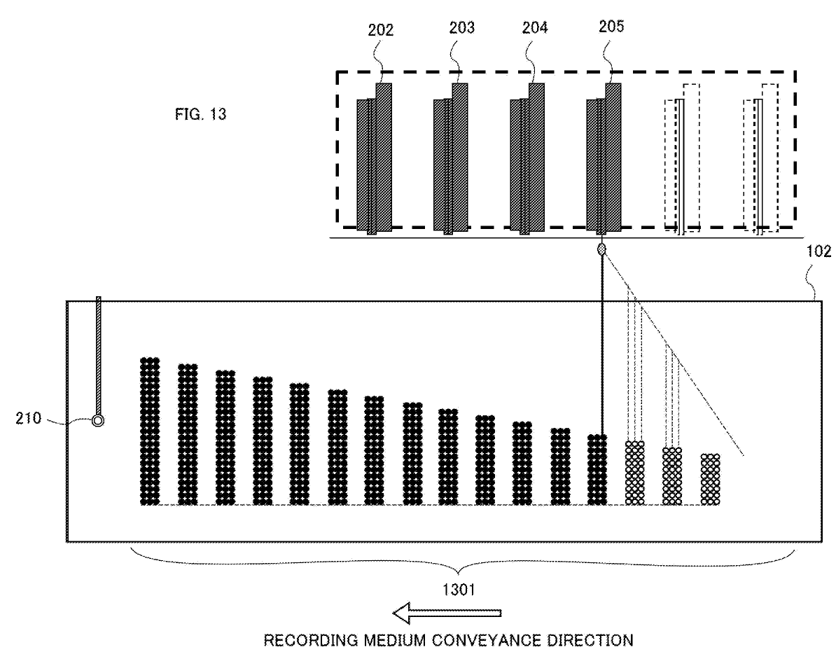

FIG. 13 is a diagram showing an example of another modification of the test pattern. The width of each line in the test pattern described above is of one dot. In contrast, the width of a line in a test pattern 1301 shown in FIG. 13 is plural dots (three dots in the figure). When the diameter of recorded one ink dot is too small for the reflective optical sensor 210 to detect a one-dot-width line properly, a test pattern using lines, each composed of plural dots, is effective. In this case, the space between the two neighboring lines may be extended as necessary. The sampling signal 802 shown in FIG. 8 may also be changed as necessary.

Also in the test pattern composed of plural-dot lines, the lines may be recorded only in a part of the central of the nozzle group 501 as described in FIG. 12.

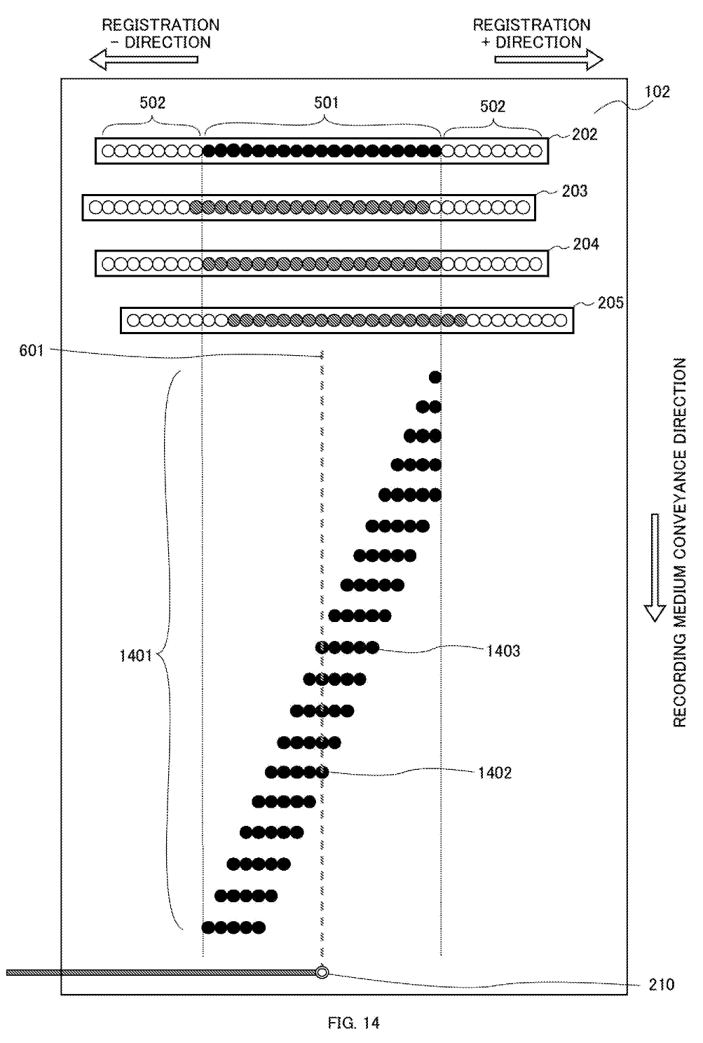

FIG. 14 is a diagram showing a still another example of a modification of the test pattern. In the test patterns described above, the position of one end of the lines is fixed. In contrast, the positions of both ends of the lines in a test pattern 1401 shown in FIG. 14 are shifted in increment of one unit amount. In this case, in measuring the test pattern of a line recording head, the period of time from a predetermined base time to the time a line of the test pattern is detected for the first time (the time when a line 1402 is detected) is measured (or encoder output pulses are counted during the period). The “base time” is, for example, the time at which the first line of the test pattern is recorded. Alternatively, the period of time from the time a line of the test pattern is once detected after the base time to the time the line becomes undetected (the time the line immediately after a line 1403 is detected) is measured (or encoder output pulses are counted during the period). Because the distance from a line recording head to the optical sensor 210 varies depending upon individual line recording heads, the error of the “base time” is corrected based on the relation between the distance from each of the second to fourth line recording heads to the first line recording head (this distance is known) and the conveyance speed of the recording medium (this speed is also known).

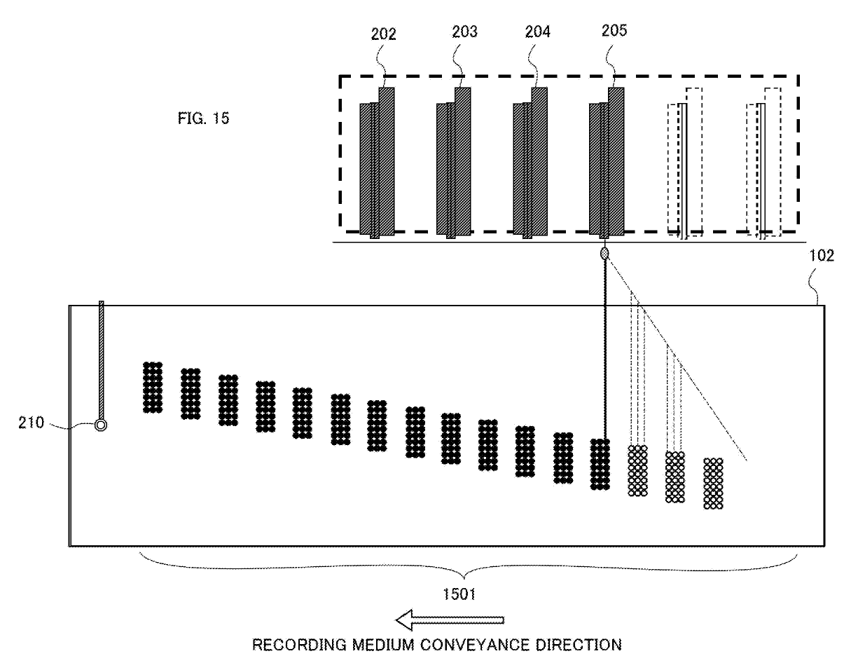

FIG. 15 is a diagram showing an example of a modification of the test pattern 1401 in FIG. 14. This test pattern 1501 is similar to the test pattern 1401 in that the positions of both ends of the lines are shifted in increments of one unit amount, but is different from the test pattern 1401 in that the width of a line is of plural dots. The difference between plural values of time measured for plural test patterns 1501 recorded by plural recording heads correspond to the registration errors among the recording heads.

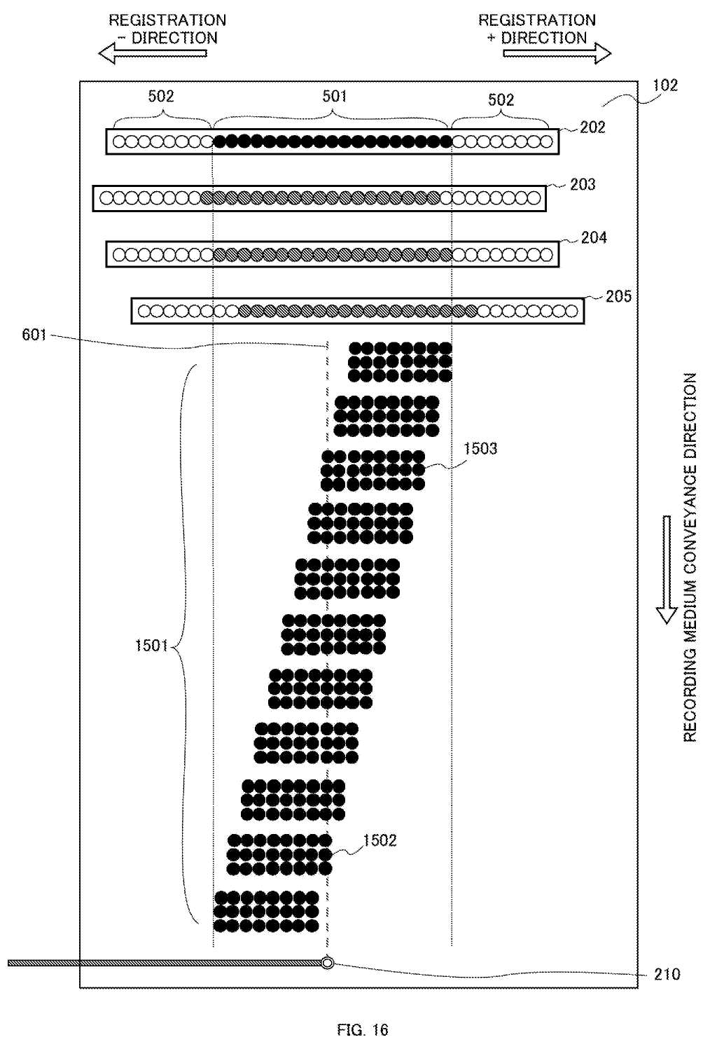

FIG. 16 is a diagram showing the measurement of the test pattern 1501 in FIG. 15. As for the test pattern 1401 shown in FIG. 14, the period of time from a predetermined base time to the time a line of the test pattern is detected for the first time (the time when a line 1502 is detected) is measured (or encoder output pulses are counted during the period). Alternatively, the period of time from the time a line of the test pattern is once detected after the base time to the time the line becomes undetected (the time the line immediately after a line 1503 is detected) is measured (or encoder output pulses are counted during the period). The “base time” and its correction are the same as those in FIG. 14.

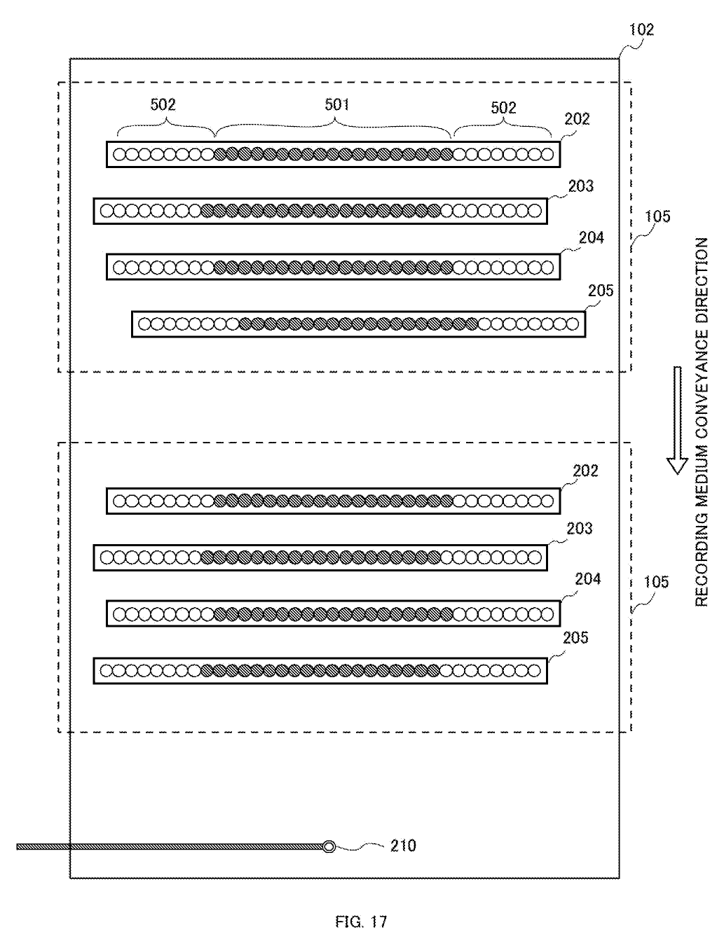

FIG. 17 is a diagram showing the registration adjustment in a system in which plural recording units 105 are arranged in tandem as in FIG. 1C. In this case, one of the plural recording units 105 is used as the base recording unit. The registration among the plural recording heads of this base recording unit is adjusted in the same way as in the example described above. In contrast, for the other recording units (called comparison recording units), the registration errors are detected and corrected for all their line recording heads with the base line recording head of the base recording unit as the base. This allows all line recording heads of all recording units to be correctly registered with the base line recording head of the base recording unit.

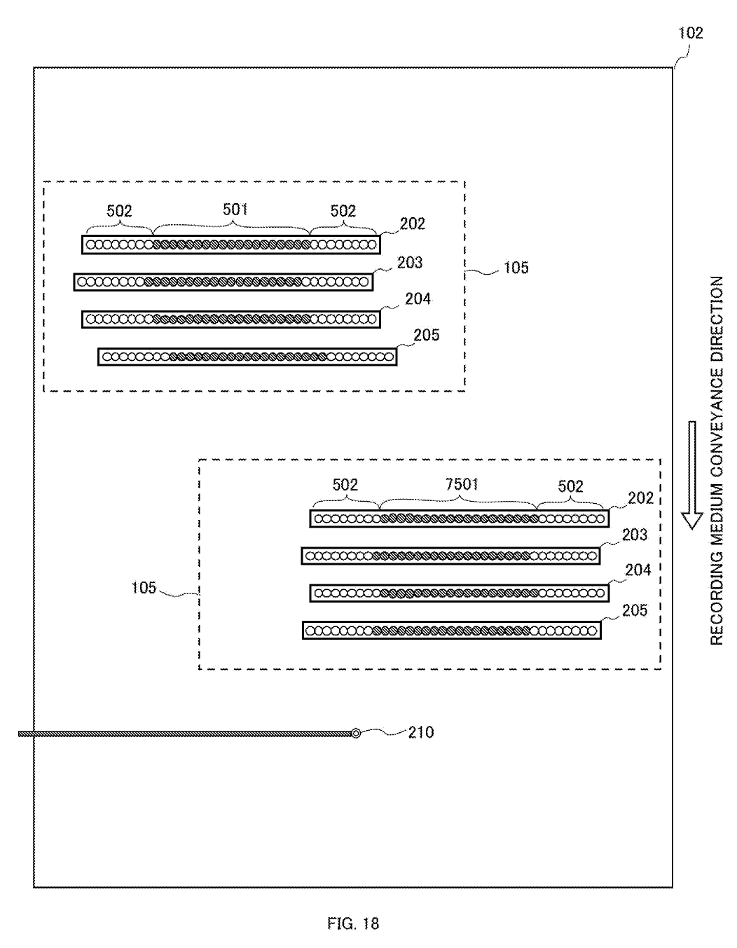

FIG. 18 is a diagram showing the registration adjustment in a system in which plural recording units 105 are arranged in zigzag as in FIG. 1B. In this case, one recording unit 105 and its neighboring other recording unit 105 have their ends (parts of nozzle groups 502) overlapped with each other as described above. The test pattern is recorded using the nozzle groups which are designed to be overlapped. The optical sensor 210 is provided in the area where the neighboring recording units are overlapped with each other. For example, the optical sensor is provided substantially in the center of the nozzle groups 502. One optical sensor 210 is provided at each boundary between the zigzag-arranged neighboring recording units 105 to allow the two recording units to share one optical sensor 210. Although only two recording units are shown in FIG. 18, three or more recording units may also be arranged. n zigzag-arranged recording units 105 require n−1 optical sensors 210. Again, in this case, one of the plural recording units is used as the base recording unit in the same way as in FIG. 17. For all line recording heads of the comparison recording units, the registration errors are detected and corrected with the base line recording head of the base recording unit as the base.

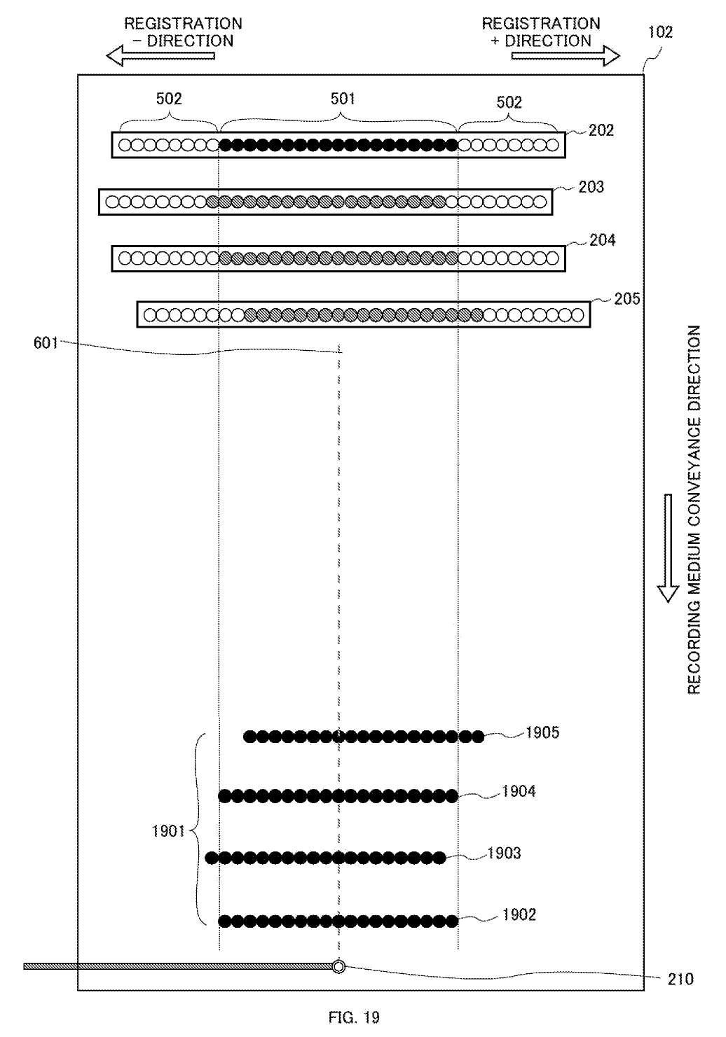

While the registration adjustment in the nozzle array direction on a dot basis has been described above, a special test pattern and a special processing program, if prepared, allow the registration to be adjusted in the direction orthogonal to the nozzle array direction (called the vertical direction for convenience). FIG. 19 is a diagram showing an example of such a test pattern. This test pattern 1901 is recorded by recording lines 1902-1905 at equal intervals using plural line recording heads 202-205. This test pattern 1901 may be recorded regardless of whether or not the registration adjustment in the nozzle array direction is completed at the time the test pattern 1901 is recorded. Even if the lines 1902-1904 are to be recorded at equal intervals but if there is a registration error among the line recording heads in the vertical direction, the lines of the recorded test pattern 1901 are not recorded at equal intervals. So, the recording medium on which the test pattern 1901 is recorded is conveyed to cause the optical sensor 210 to detect the lines for measuring the times at which they are detected. For example, the time elapsed from the time the first line is detected to the time each of the second, third, and fourth lines is detected is measured and the values of measured time are compared with the expected time to find the errors, ΔT1, ΔT2, and ΔT3, between the measured time and the expected time. By correcting the time at which ink is ejected from each line recording head so that this error is canceled, the registration in the vertical direction can be adjusted. With the test pattern 1901 and the optical sensor 210, this registration adjustment in the vertical direction can be made automatically.

The width of a line of the registration adjustment test pattern in the vertical direction may also be plural dots as described above.

While the preferred embodiment of the present invention has been described, it is to be understood that, in addition to those described above, various modifications and changes may be made.

For example, though an inkjet image forming device that has four black heads as line recording heads and that records an image in raster division mode is described in the example above, the present invention is applicable also to a color inkjet image forming device that uses plural, different-color line recording heads. In this case, plural optical sensors are provided, one for each ink color, as readers in the same position in the nozzle array direction. Preferably, the position of each optical sensor is calibrated. For use as another type of reader, the color filters for the same optical sensor may be switched according to the color of the ink of the test pattern.

1. For use in an inkjet image forming device that records an image while conveying a recording medium below a plurality of line recording heads in a direction substantially orthogonal to a nozzle array direction, a registration error detection method for detecting a registration error in the nozzle array direction among said plurality of line recording heads, each of said plurality of line recording heads having linearly-arranged nozzle arrays, said registration error detection method comprising the steps of:
recording, by each of the line recording heads, a test pattern composed of a plurality of lines running along the nozzle array, at least one end positions of the lines being shifted in increments of one unit amount;
detecting, by an optical sensor, lines of the test pattern recorded by each of the line recording heads, said optical sensor being provided downstream of said plurality of line recording heads in a conveyance direction of the recording medium; and
detecting an amount of registration error in the nozzle array direction between one line recording head, which is one of said plurality of line recording heads and is used as a base, and other line recording heads, based on line detection results of the test patterns recorded by the line recording heads.

2. An inkjet image forming device that records an image while conveying a recording medium below a plurality of line recording heads in a direction substantially orthogonal to a nozzle array direction, each of said plurality of line recording heads having linearly-arranged nozzle arrays, said inkjet image forming device comprising:
a recording unit that records, by each of the line recording heads, a test pattern composed of a plurality of lines running along the nozzle array, at least one end positions of the lines being shifted in increments of one unit amount;
an optical sensor provided downstream of said plurality of line recording heads in a conveyance direction of the recording medium; and
a control unit that causes said optical sensor to detect the lines of the test pattern recorded by each line recording head, finds an amount of registration error in the nozzle array direction between one line recording head, which is one of said plurality of line recording heads and is used as a base, and other line recording heads based on line detection results of the test patterns recorded by the line recording head, and corrects a nozzle array direction registration of each line recording head based on the amount of error.

3. The inkjet image forming device according to claim 2 wherein said plurality of line recording heads eject ink of the same color and said optical sensor is shared by said plurality of line recording heads.

4. The inkjet image forming device according to claim 2 wherein said plurality of line recording heads eject ink of different colors and a plurality of units of said optical sensor are provided, one for each color.

5. The inkjet image forming device according to claim 2 wherein said plurality of line recording heads eject ink of different colors and color filters for said optical sensor are switched according to ink color.

6. The inkjet image forming device according to claim 2 wherein the test pattern has a shape one end of which is shifted in increments of one dot, line by line, each line being of a predetermined line width.

7. The inkjet image forming device according to claim 6 wherein the predetermined line width is of one dot.

8. The inkjet image forming device according to claim 6 wherein the predetermined line width is of a plurality of dots.

9. The inkjet image forming device according to claim 6 wherein neighboring lines have a blank area therebetween.

10. The inkjet image forming device according to claim 2 wherein lines detected by said optical sensor are counted for the test pattern recorded by each line recording head and, based on a difference between the number of lines of the base line recording head and the number of lines of other line recording heads, the amount of registration error is detected.

11. The inkjet image forming device according to claim 2 wherein, for the test pattern recorded by each line recording head, encoder output pulses, which are output in synchronization with the conveyance of a recording medium, are counted for a period of time from a base time to a time at which the test pattern is detected by said optical sensor and, based on the count, the amount of registration error is detected.

12. The inkjet image forming device according to claim 2 wherein, for the test pattern recorded by each line recording head, encoder output pulses, which are output in synchronization with the conveyance of a recording medium, are counted for a period of time from a base time to a time at which the test pattern becomes undetected by said optical sensor and, based on the count, the amount of registration error is detected.

13. The inkjet image forming device according to claim 2 wherein, when said inkjet image forming device has at least first and second recording units arranged in tandem, said optical sensor is shared by said first and second recording units, each of said first and second recording units including said plurality of line recording heads.

14. The inkjet image forming device according to claim 2 wherein, when said inkjet image forming device has at least first and second recording units arranged in different positions in the width direction of the recording medium for causing said first and second recording units to record images in different parts on the recording medium in the width direction, said recording units are arranged so that parts of nozzle arrays of neighboring recording units are overlapped with each other in the width direction, the test pattern is recorded in the overlapped nozzle part, and said optical sensor is provided in the overlapped area of the neighboring recording units to allow the neighboring recording units to share the same optical sensor, each of said first and second recording units including said plurality of line recording heads.

15. The inkjet image forming device according to claim 13 wherein, with a base line recording head of a specific recording unit as a base, the amounts of errors of all line recording heads of other recording units are detected and corrected.
